(19) United States
(12) Patent Application Publication
(10) Pub. No.: US 2005/0230432 A1
(43) Pub. Date: Oct. 20, 2005

(54) AIR OPERATED GROUT TOOL

(76) Inventor: H. Dean Jorgenson, Willow City, TX (US)

Correspondence Address: GREENBERG & LIEBERMAN, 314 PHILADELPHIA AVE., TAKOMA PARK, MD, 20912, US

(21) Appl. No.: 10/709,159

(22) Filed: Apr. 16, 2004

(51) Int. Cl. B67D 5/42

(52) U.S. Cl. 222/389

(57) ABSTRACT

The air operated grout tool is a device used to apply grout directly between tiles. The air operated grout tool allows for the neat, precise, effective and efficient application of grout. It eliminates the exhaustive and strenuous manual labor usually associated with applying grout. The present invention attaches to a conventional air supply, which causes pressure to travel into the present invention. The pressure causes a smooth and continuous flow of grout from the air operated grout tool. The grout passes through a hollowed needle attachment that directs the grout directly into the crevices between the tiles.

### BACKGROUND OF INVENTION

The present invention relates to a grout-applying tool to form grouting joints between adjacent tiles laid on a surface, and more particularly to a grout tool that makes the process of tile grout application more swift and efficient.

Ceramic tile floors and other surfaces are extremely popular decorating choices in homes and businesses. One of the prime reasons for their popularity is that ceramic tiles handle heavy traffic areas well, and show little signs of wear and tear.

Tile surfaces are constructed by securing individual tile elements in a spaced side-by-side fashion. In order to create the tile pattern, a ¼″″ to ¾″ space usually lies between each tile element. After tiles are placed in this manner a grout material such as cement is applied between the tiles to provide a decorative effect as well as a hard, solid, finish. A variety of cement additives may be used to create grout having different qualities such as color, mildew resistance, hardeners, etc.

Often when constructing tile surfaces, grout application has been done manually sponging grout into place. By hand, a user pours the grout between the tiles and sponges the excess grout to form grouting joints. While this method results in constructing a solid tile surface, the method is extremely expensive because it is physically overwhelming, time consuming and lots of grout material is wasted as it is sponged away. Also, hand contact with resin-based grout used for forming epoxy grouting is hazardous for the user. Contact or inhalation of resin vapors can result in damaging the health of the user.

U.S. Pat. No. 5,246,143 issued to Cherfane on Sep. 21, 1993 is for a thermal insulation grade foam dispensing system mixes and dispenses insulation, unlike the present invention which dispenses grout consistently due to forceful, yet controlled for safety air pressure.

U.S. Pat. No. 5,342,149 issued to McCabe et al. on Aug. 30, 1994 is a long hole chemical grout injector system that is powered by hydraulic pressure, unlike the present invention which provides continuous air pressure.

U.S. Pat. No. 3,603,487 issued to Cook on Nov. 17, 1969 is an inline sealant dispenser that has a socket member receiving the rear end of a cartridge assembly containing the sealant, unlike the present invention that does not require a cartridge.

Thus, there is a need for a grout applicator that precisely directs grout in between tiles, which is pressurized by an even flow of continuous air pressure, eliminates the manual labor associated with sponging to remove excess grout, increases the speed and efficiency of grouting tile and the tile application.

### SUMMARY OF INVENTION

The present invention is a tile grout applicator that has a cylinder bounded by a top cap and a bottom cap. A first nozzle is at the top cap and a second nozzle is at the bottom cap. An internal plunger responds to pressure introduced into the cylinder from the first nozzle so that grout within the cylinder is pushed out the second nozzle. The first nozzle is attached to an air pressure assembly.

The air pressure entering the first nozzle is regulated to make the tool dispense grout at a rate that is needed to fill gaps between the tiles. Usually, the pressure is between 15-30 psi for the safe operation of the present invention, such that grout exits the second nozzle at a reasonable speed without causing too much mess.

### BRIEF DESCRIPTION OF DRAWINGS

FIG. 1 is an environmental perspective view of the present invention.

FIG. 2 is a cross-sectional side view of the present invention.

### DETAILED DESCRIPTION

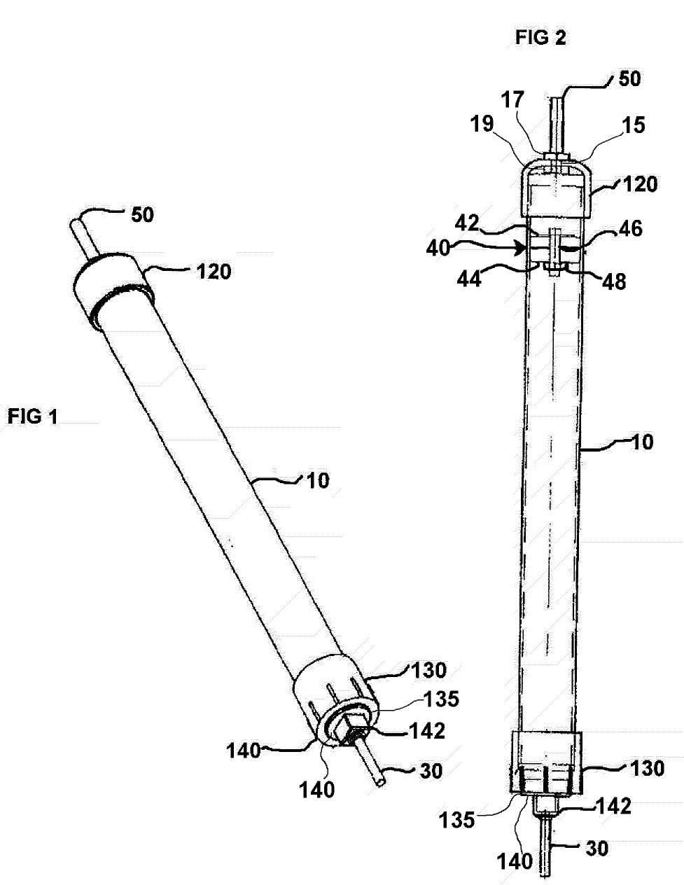

FIGS. 1 and 2 show features and details of the present invention. The present invention has a cylinder 10, a top cap 120, a first nozzle 50, a plunger 40, a second nozzle 30, and a bottom cap 130. Together, these main parts of the present invention allow it to function.

The cylinder 10 has a first aperture 15 in the center of its closed end, and through aperture 15 is placed first nozzle 50. First nozzle 50 is a conventionally threaded tube, and it is secured within first aperture 15 via first nut 17 and second nut 19. Once first nozzle 50 is placed through first aperture 15, first nut 17 and second nut 19 are rotated along first nozzle 50 so as to hold it firmly against top cap 120. When secured against top cap 120, first nozzle 50 his held so that first nut 17 is on the outside of top cap 120 and second nut 19 is on the inside of top cap 120.

Top cap 120 is fixedly attached to cylinder 10 via any conventional means, such as cement, glue, threads, and friction fit. Top cap should be attached to cylinder 10 once top cap 120 has been fitted with first nozzle 50 as aforementioned.

Within cylinder 10 is placed plunger 40, and it is formed via first disk 42 and second disk 44 placed atop one another. A bolt 46 is placed within first disk 42 and second disk 44, and bolt 46 is tightened via third nut 48. As third nut 48 is tightened onto bolt 46, first disk 42 and second disk 44 are sandwiched between third nut 48 and bolt 46. Because first disk 42 and second disk 44 are flexible, as they are sandwiched, first disk 42 and second disk 44 expand outward against the inside wall of cylinder 10. It is desirable to sandwich first disk 42 and second disk 44 enough so that they expand against cylinder 10 so that they can move through cylinder 10 while maintaining a seal preventing passage of air and/or material completely throughout cylinder 10.

The open end of cylinder 10 has a bottom cap 130 that removably attaches to cylinder 10 via any conventional means, such as threads, friction fit, and the like. It is important that bottom cap 130 can be removed from cylinder 10 because grout is placed into cylinder 10 by removing bottom cap 130; however, bottom cap 130 must be secured to cylinder 10 so that the present invention can dispense grout.

Bottom cap 130 has second aperture 135 though one of its ends, and second aperture 135 is threaded. Nozzle holder 140 communicates with the threads of second aperture 135 to form a tight fit with bottom cap 130 while the present invention is in use; however nozzle holder 140 can easily be unscrewed from second aperture 135 for access and cleaning of the present invention. In terms of shape, nozzle holder 140 has a nut-shaped adaptation 142 that aids in screwing nozzle holder 140 into aperture 135. A third aperture is positioned on nut-shaped adaptation 142, and through nut-shaped adaptation 142 is disposed second nozzle 30.

Second nozzle 30 is secured through nut-shaped adaptation 142, and thus, to nozzle holder 140 via a fourth nut 150 and a fifth nut 160. Fourth nut 150 and fifth nut 160 are attached to second nozzle 30, which is threaded, so that fourth nut 150 and fifth nut 160 sandwich nut-shaped adaptation 142, and thereby secure second nozzle 30 to nut-shaped adaptation 142.

To operate the present invention, the user first makes sure that the plunger 40 is close to the top cap 120 of the present invention, as shown in FIG. 2. Next, the user must remove a bottom cap 130 to put grout inside the present invention. Next, the user must fill the cylinder 10 with the grout. Next, the user reattaches the bottom cap 130 that was removed to allow the user to fill cylinder 10 with the grout. Bottom cap 130 communicates with cylinder 10 in any conventional way that permits attachment, separation, and reattachment. The other aforementioned parts of the present invention are not separated and/or removed in normal operation but for cleaning purposes.

The bottom cap 130 can also receive different sized second nozzles 30 that are used for various necessary grout widths, which is determined by how much space there is between the tiles to which the user is applying grout the wider the space between any tiles, the wider the second nozzle 30 must be to apply a proper width of grout.

Once the grout is within the cylinder 10, the first nozzle 50 is attached to a conventional air pressure source. The conventional air pressure source typically has a hose that attaches to first nozzle 50. The air from the air pressure source, delivered between 15-30 psi, enters the present invention via first nozzle 50, and pushes plunger 40 down in cylinder 10. As plunger 40 moves down cylinder 10, plunger 40 pushes grout out of cylinder 10 via second nozzle 30. If the air pressure source delivers air at too high or too low a psi, then the grout will either not exit second nozzle 30 fast enough for reliable placement or not exit second nozzle 30 slow enough for near placement.

While the present invention has been described herein, it is to be understood that the present invention is not limited thereto. Numerous changes and modifications may be made therein without departing from the spirit and the scope of the invention as defined in the appended claims.

1. A device for dispensing grout, comprising:
a grout holding member;
a plunger member, within said grout holding member; and
first nozzle member, in communication with said grout holding member.

2. The device of claim 1, further comprising a second nozzle member.

3. The device of claim 1, further comprising a removable first nozzle.

4. The device of claim 1, in combination with a source of compressed air.

5. The device of claim 1, wherein said grout holding member is a cylinder.

6. The device of claim 1, wherein said plunger member is a disc shaped.

7. The device of claim 1, wherein said plunger member expands to fill a horizontal plane within said grout holding member.

8. The device of claim 1, wherein said first nozzle member is adapted to receive compressed air.
